(19) United States
(12) Patent Application Publication
(10) Pub. No.: US 2018/0302761 A1
(43) Pub. Date: Oct. 18, 2018

(54) Recommendation System for Multi-party Communication Sessions

(71) Applicant: Google Inc., Mountain View, CA (US)

(72) Inventors: Nicholas Delmonico Rizzolo, Cupertino, CA (US); Nisarg Dilipkumar Kothari, Sunnyvale, CA (US); Ullas Gargi, Sunnyvale, CA (US)

(21) Appl. No.: 13/659,728

(22) Filed: Oct. 24, 2012

(51) Int. Cl. H04W 4/21; H04L 12/58

(52) U.S. Cl. CPC H04W 4/21; H04L 51/10

(57) ABSTRACT

The disclosure includes a system and method for recommending multi-party communication sessions. The system includes: a user model module, a content model module and a determination module. The user model module determines a user social interest model based at least in part on user profile data. The content data module determines interest data describing content data associated with one or more content identifiers. The content model module determines one or more content models describing the content data. The determination module determines whether a match exists between the user social interest model and the one or more content models. The determination module determines the one or more multi-party communication sessions for the recommendation responsive to determining the match exists between the user social interest model and the one or more content models.

### BACKGROUND

The specification relates to providing recommendations for multi-party communication sessions to a user.

The popularity of electronic communications using online social networks has grown over the years. Some social networks provide real-time chat services, e.g., instant messaging, video conferencing and voice chat, for communication over the Internet between at least two members of the social network. Users may share their views, interests, and activities via these multi-party communication sessions. They may participate in a multi-party communication session, either synchronously, in groups, to communicate in real-time (for example, to “video chat”) or to share activities (for example, to view video content), or otherwise interact with one another asynchronously in “chat” forums. To find multi-party communication sessions to join, a user may use search queries that provide results that are uninteresting or irrelevant to the user. Thus, manual searches may waste a user's time and computer resources.

### SUMMARY

According to one innovative aspect of the subject matter described in this disclosure, a system for recommending multi-party communication sessions to a user includes: a controller for receiving a request for a recommendation describing one or more multi-party communication sessions on a social network from a user; a user model module for retrieving user profile data for the user and for determining a user social interest model based at least in part on the user profile data; a content data module for determining one or more content identifiers associated with the multi-party communication sessions on the social network and for determining interest data describing content data associated with the one or more content identifiers; a content model module for determining one or more content models describing the content data; a determination module for determining whether a match exists between the user social interest model and the one or more content models and for determining the one or more multi-party communication sessions for the recommendation responsive to determining the match exists between the user social interest model and the one or more content models, the one or more content identifiers associated with the one or more multi-party communication sessions; and a graphical user interface module for transmitting the recommendation to the user.

In general, another innovative aspect of the subject matter described in this disclosure may be embodied in methods that include: receiving a request for a recommendation describing at least one communication session on a social network from a user; retrieving user profile data for the user; determining a user interest model based on the user profile data; determining at least one content identifier associated with a plurality of communication sessions on the social network; determining interest data describing content data associated with the at least one content identifier; determining at least one content model describing the content data; determining whether a match exists between the user interest model and the at least one content model; determining the at least one communication session for the recommendation responsive to determining the match exists between the user interest model and the at least one content model, wherein the at least one content identifier is associated with the at least one communication session; and transmitting the recommendation to the user.

Other aspects include corresponding methods, systems, apparatus, and computer program products for these and other innovative aspects.

These and other implementations may each optionally include one or more of the following features. For instance, the operations include: receiving a social graph for the user from the social network and comparing connections in the social graph for the user and participants of the one or more multi-party communication sessions; and determining a score for the match. For instance, the features include: the user social interest model may include a first vector of binary values; the one or more content models may include a second vector of binary values and each binary value may correspond to an entity describing an interest; the user profile data may include a recent browsing history of the user; the content data may include one or more videos; the one or more multi-party communication sessions may include a queue of videos to be played including the one or more videos; the at least one content model is determined based at least in part on the interest data; and determining whether the match exists includes comparing connections in a social graph for the user and one or more participants of the at least one communication session.

The technology may be particularly advantageous in a number of respects. The system provides recommendations to the user based on matching content associated with a multi-party communication session and a profile of a user. Therefore, the recommendations provide the user with an opportunity to participate in interesting and relevant multi-party communication sessions. Also, the user beneficially saves time by avoiding the process of manually searching for interesting multi-party communication sessions.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example of a recommendation system for multi-party communication sessions.

FIG. 2 is a block diagram illustrating an example of a recommendation system.

FIG. 3 is a flowchart of an example method for recommending multi-party communication sessions.

FIGS. 4A-4D are flowcharts of another example method for recommending multi-party communication sessions.

FIG. 5 is a graphic representation of an example user interface for recommending multi-party communication sessions.

### DETAILED DESCRIPTION

In some implementations, the system receives a request for a recommendation describing one or more multi-party communication sessions on a social network application from a user. The system retrieves user profile data for the user. For example, the user profile data includes one or more of data describing a recent browsing history of the user, data describing a content consumption history of the user and current activity data describing a current activity of the user. The system determines a user social interest model for the user based at least in part on the user profile data. In some implementations, the user social interest model includes a vector of binary values, and each binary value in the vector corresponds to an entity describing an interest.

The system determines one or more content identifiers associated with multi-party communication sessions on the social network application. The system determines interest data describing content data associated with the one or more content identifiers. The system determines one or more content models associated with the content data. In some implementations, a content model includes a vector of binary values that describe the content data. The system determines whether a match exists between the user social interest model and the one or more content models. For example, the system determines a score between the user social interest model and a first content model from the one or more content models, and determines that a match exists between the user social interest model and the first content model if the score exceeds a predetermined score threshold. Responsive to determining the match exists, the system determines one or more multi-party communication sessions to be included the recommendation based at least in part on the match, and transmits the recommendation to the user.

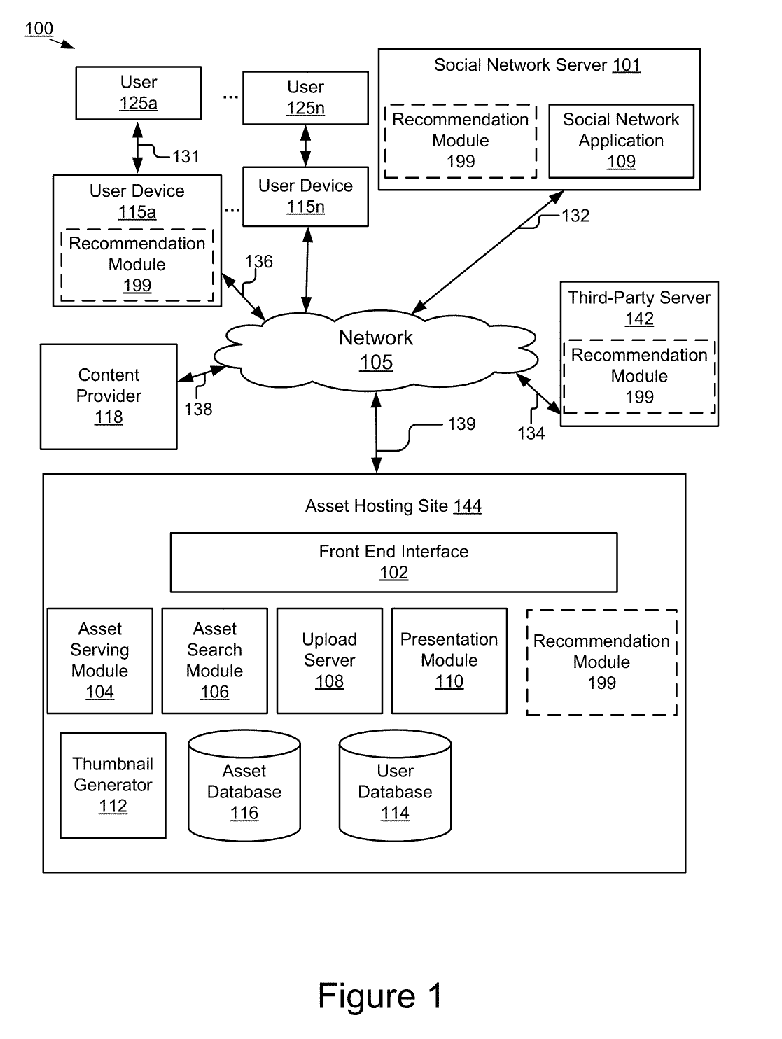

FIG. 1 illustrates a block diagram of some instances of a recommendation system 100 for multi-party communication sessions. The illustrated recommendation system 100 includes user devices 115a . . . 115n that can be accessed by users 125a . . . 125n, a social network server 101, a content provider 118, a third-party server 142 and an asset hosting site 144. In the illustrated instance, these entities of the recommendation system 100 are communicatively coupled via a network 105. In FIG. 1 and the remaining figures, a letter after a reference number, e.g., “115a,” can be a reference to the element having that particular reference number. A reference number in the text without a following letter, e.g., “115,” can be a general reference to any or all instances of the element bearing that reference number. Although only one social network server 101, one content provider 118, one third-party server 142 and one asset hosting site 144 are illustrated, any number of social network servers 101, content providers 118, third-party servers 142 and asset hosting sites 144 can be communicatively coupled to the network 105. Although only two devices are illustrated, any number of user devices 115n can be available to any number of users 125n. Furthermore, while only one network 105 is coupled to the user devices 115a . . 115n, the social network server 101, the content provider 118, the third-party server 142 and the asset hosting site 144, any number of networks 105 can be connected to the user devices 115a . . 115n, the social network server 101, the content provider 118, the third-party server 142 and the asset hosting site 144.

The network 105 can be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some instances, the network 105 may be a peer-to-peer network. The network 105 may also be coupled to or includes portions of a telecommunications network for sending data in a variety of different communication protocols. In some instances, the network 105 includes Bluetooth communication networks or a cellular communications network for sending and receiving data including via short messaging service (SMS), multimedia messaging service (MMS), hypertext transfer protocol (HTTP), direct data connection, WAP, email, etc.

In some instances, a recommendation module 199 may be operable on the social network server 101, which is communicatively coupled to the network 105 via signal line 132. The social network server 101 can be a hardware server that includes a processor, a memory and network communication capabilities. In some instances, the social network server 101 sends and receives data to and from one or more of the user devices 115, the content provider 118, the third-party server 142 and the asset hosting site 144 via the network 105. The social network server 101 includes a social network application 109 and a social graph (not pictured). The social network application 109 stores explicitly defined relationships and relationships implied by social connections with other online users as a social graph. In some examples, the social graph can reflect a mapping of these users and how they can be related. Furthermore, the social network server 101 and the social network application 109 may be representative of one social network and that there may be multiple social networks coupled to the network 105, each having its own server, application and social graph. For example, a first social network may be directed to business networking, a second may be directed to or centered on academics, a third may be directed to local business, a fourth may be directed to dating and others may be of general interest or a specific focus.

In some instances, the social network application 109 manages multi-party communication sessions. The social network application 109 allows multiple users 125 to communicate in multi-party communication sessions. For example, participants of the multi-party communication session can be all connected to the social network server 101, which may be a central server. In some instances, a multi-party communication session uses peer-to-peer communication.

In one instance, the multi-party communication session includes a primary user (e.g., a moderator) and one or more secondary users and allows the users 125 to communicate with one another. In one instance, communication between one or more users 125 can be unilateral. For example, a user 125 in the multi-party communication session may see and/or hear the other participants in the multi-party communication session, but the user 125 may not be seen and/or heard by the other users 125. In one instance, a multi-party communication session can be public allowing any user 125 to join the multi-party communication session. In other instances, a multi-party communication session can be private. A private multi-party communication session may require an invitation for a user 125 to join the private multi-party communication sessions. In some instances, a user 125 must be logged-in (e.g., logged into the social network server 101) in order to join a multi-party communication session.

A multi-party communication session allows for one or more of audio and visual communication. Examples of a multi-party communication session include but are not limited to one or more of a chat session, voice conference, video conference, etc. In one instance, a multi-party communication session displays video or other representations of participating users 125. In one such instance, the multi-party communication session includes both audio and video communication. It will be realized that the preceding are merely examples of multi-party communications sessions and that other examples exist.

In some instances, multimedia content can be consumed by participants during a multi-party communication session. For example, the participants may share or view content such as videos, photos, images, music, the text of present or past chat sessions, etc. during the multi-party communication session. The content can include any other type of content capable of being hosted by the asset hosting site 144. In some instances, the asset hosting site 144 may provide the multimedia content consumed during the multi-party communication session. In some instances, the content provider 118 may provide the multimedia content consumed during the multi-party communication session.

In some instances, the social network application 109 provides multi-party communication session data describing multi-party communication sessions managed by the social network application 109. For example, the multi-party communication session data may include a description, a name, a list of participants, a session type (e.g., chat session, voice conference, video conference), a privacy type (e.g., public, private), a status (e.g., in progress, scheduled for a future time) and/or associated content data. In some instances, the associated content data includes one or more identifiers that identify the content. The identifiers may identify content or assets hosted by asset hosting site 144. In some instances, the identifiers may be stored in the asset database 116. The identifiers may be associated with the content stored on the asset database 116. For example, the identifiers identify a video, image, music file or any other content and an association between the identifiers and the content they point to can be stored on the asset database 116.

The asset hosting site 144 can be any system that allows a user 125 to access an intellectual property asset via searching and/or browsing interfaces. The asset hosting site 144 can be a hardware server that includes a processor, a memory and network communication capabilities. It will be understood that the term “web site” represents any computer system adapted to serve content using any internet working protocols, and is not intended to be limited to content uploaded or downloaded via the Internet or the HTTP protocol.

In one instance, the asset hosting site 144 can be configured to receive and share all or a portion of an intellectual property asset. Examples of an intellectual property asset include, but are not limited to: a video; one or more songs; a video game; a book; etc. An intellectual property asset can be represented in any media type and/or file type. For example, the asset hosting site 144 shares content, e.g., a video file, an audio file (e.g., one or more songs), a file that includes a combination of video and audio, an image file including a JPEG or GIF file, a file including a video game program, a text file. An intellectual property asset is referred to as “an asset” hereinafter.

In one instance, sources of assets provided by the asset hosting site 144 are from uploads of assets by users 125, searches or crawls of other web sites or databases of assets, or the like, or any combination thereof. For example, in one instance, an asset hosting site 144 can be configured to allow uploads of assets by users 125. In some instances, the asset hosting site 144 can be configured to only obtain assets from other sources by crawling such sources or searching such sources in real time.

The asset hosting site 144 is communicatively coupled to the network 105 via signal line 139. In the illustrated instance, the asset hosting site 144 includes: a front end interface 102; an asset serving module 104; an asset search module 106; an upload server 108; a presentation module 110; a thumbnail generator 112; a user database 114; and an asset database 116. In some instances, the recommendation module 199 may be operable on the asset hosting site 144. In one instance, the components of the asset hosting site 144 are communicatively coupled to one another. For example, they are communicatively coupled to one another via a bus (not pictured). Other conventional features (e.g., firewalls, load balancers, authentication servers, application servers, failover servers, site management tools) are not shown so as not to obscure the feature of the system.

In one instance, the illustrated components of the asset hosting site 144 can be implemented as single pieces of software or hardware or as multiple pieces of software or hardware. In general, functions described in one instance as being performed by one component, can also be performed by other components in other instances, or by a combination of components. Furthermore, functions described in one instance as being performed by components of the asset hosting site 144 can be performed by one or more user devices 115 in other instances if appropriate. In one instance, the functionality attributed to a particular component can be performed by different or multiple components operating together.

The front end interface 102 can be an interface that handles communication with one or more of the content provider 118, the user device 115, the social network server 101 and the third-party server 142 via the network 105. For example, the front end interface 102 receives an asset uploaded from the content provider 118 and delivers the asset to the upload server 108. In one instance, the front end interface 102 receives requests from users 125 of the user devices 115 and delivers the requests to the other components of the asset hosting site 144 (e.g., the asset search module 106 or the asset serving module 104). For example, the asset can be a video and the front end interface 102 receives a video search query from a user 125 and sends the video search query to the asset search module 106.

The upload server 108 receives one or more assets from the content provider 118 via the front end interface 102. For example, the upload server 108 receives one or more of a video file, an audio file (e.g., one or more songs), a file that includes a combination of video and audio, an image file including a JPEG or GIF file, a file including a video game program and/or a text file from the content provider 118. In one instance, the upload server 108 processes the one or more assets and stores the processed assets in the asset database 116. The upload server 108 assigns an asset identification (“asset ID”) to the stored asset. In some instances, an asset ID may be referred to as a content identifier. An asset ID includes identifiers for videos (“video ID”), songs (“song ID”), images (“image ID”), video games (“video game ID”) and books (“book ID”). For example, the upload server 108 assigns a video ID to a video and stores the video together with the video ID in the asset database 116. In other instances, the upload server 108 performs one or more of: formatting an asset; compressing an asset; metadata tagging an asset; content analysis, etc.

The asset database 116 can be a storage system that stores assets shared by the asset hosting site 144 with the users 125. In one instance, the asset database 116 stores the assets processed by the upload server 108. In some instances, the asset database 116 also stores metadata associated with the assets. The metadata includes one or more of: a title; a description; tag information; a time length; and the like. In one instance, some or all of the metadata of the assets can be provided by the content provider 118. For example, a user of the content provider 118 provides a title and a description of an asset when uploading the asset to the asset hosting site 144.

In some instances, the asset database 116 stores user-generated content. The content may be generated by user 125 while participating in a multi-party communication session. For example, the content may be text during a text chat between users 125. In another example, the content may be text from a voice or video chat between users 125. A speech-to-text system may generate the text by parsing the voice or video chat. In another example, the content may be content shared between users 125. The users 125 may share photos, music, links, etc, during the multi-party communication session. The user-generated content may be any content generated by a user 125. The upload server 108 may assign an asset identification (“asset ID”) to each user-generated content.

The asset search module 106 includes code and routines that, when executed by a processor (not pictured), processes any search queries received by the front end interface 102 from users 125. A search query received by the front end interface 102 from a user 125 includes search criteria including keywords that identify an asset the user 125 can be interested in. The asset search module 106 uses the search criteria to query the metadata of the asset stored in the asset database 116. The search results for the query can be returned to the front end interface 102 for presentation to the user 125. For example, if a user 125 provides the front end interface 102 with a keyword search query, the asset search module 106 identifies an asset stored in the asset database 116 related to the keyword and returns the search result (e.g., asset IDs and/or metadata including titles, descriptions, thumbnails of the identified assets) to the front end interface 102.

The asset serving module 104 includes code and routines that, when executed by a processor (not pictured), processes requests for an asset (e.g., a video, a book, a picture, a music file) and provides the asset to users 125. For example, the asset serving module 104 receives a query from a user 125 via the front end interface 102, retrieves a set of videos from the asset database 116 based at least in part on the query and presents the set of videos to the user 125 via the front end interface 102.

In one instance, the asset serving module 104 receives a request from a user 125 to access an asset when the user 125 clicks on a link to the asset. The request received from the user 125 includes the asset ID of the asset that the user 125 wishes to access. In one instance, the asset ID can be included automatically in the request once the user 125 clicks on the link for the asset. The asset serving module 104 uses the asset ID to search and locate the asset in the asset database 116. Once the requested asset can be located, the asset serving module 104 transmits the asset to the user 125 via the front end interface 102. The asset can be presented to the user 125 on a web page. Metadata associated with the asset can also be presented with the asset, e.g., the title and description of the asset. In one instance, the asset serving module 104 stores the asset ID of the asset in the user database 114 after sending the asset to the user 125 so that an asset history of the user 125 can be stored in the user database 114.

The user database 114 can be a storage system that stores data and/or information associated with a user 125. For example, the user database 114 stores the asset IDs of assets uploaded by a user 125 to the asset hosting site 144 and the asset IDs of assets that the user 125 has accessed from the asset database 116. In one instance, the user 125 can be identified by using a login name and password and/or by using the user's internet protocol address.

The thumbnail generator 112 includes code and routines that generates a thumbnail for an asset. A thumbnail can be a picture that represents an asset in the asset hosting site 144. For example, assume the asset can be a video. The thumbnail generator 112 analyzes the video and selects a frame of the video as the thumbnail. In one instance, the thumbnail generator 112 provides one or more pictures for the video and the user 125 uploading the video to the asset hosting site 144 selects one picture as the thumbnail.

The presentation module 110 includes code and routines that, when executed by a processor (not pictured), presents any information intended for a user 125 to a corresponding client device, e.g., the user device 115. For example, the presentation module 110 generates a graphic associated with the assets stored in the asset database 116. The presentation module 110 sends the graphic to a browser application (not pictured) installed in the user device 115 via the front end interface 102 and the network 105.

The content provider 118 can be any device that provides assets to the asset hosting site 144. For example, the content provider 118 can be a computing device that uploads an asset to the asset hosting site 144. The content provider 118 is communicatively coupled to the network 105 via signal line 138. In one instance, the content provider 118 can be also a user device 115. In some instances, the content provider 118 can be the same entity that operates the asset hosting site 144.

In one instance, the content provider 118 can be configured to operate a client device to perform various content provider functions. Examples of the content provider functions include, but are not limited to: uploading an asset to the asset hosting site 144; editing an asset stored by the asset hosting site 144; removing an asset from the asset hosting site 144; and editing content provider preferences associated with an asset.

The recommendation module 199 can be code and routines for recommending multi-party communication sessions. In some instances, the recommendation module 199 can be implemented using hardware including a field-programmable gate array (FPGA) or an application-specific integrated circuit (ASIC). In some other instances, the recommendation module 199 can be implemented using a combination of hardware and software. In some instances, the recommendation module 199 may be stored in a combination of the devices and servers, or in one of the devices or servers.

In some instances, the recommendation module 199 may be stored on a user device 115a, which is communicatively coupled to the network 105 via signal line 136. In some instances, the user device 115a, 115n may be a computing device that includes a memory and a processor, for example a laptop computer, a desktop computer, a tablet computer, a mobile telephone, a personal digital assistant (PDA), a mobile email device, a portable game player, a portable music player, a reader device, a television with one or more processors embedded therein or coupled thereto or other electronic device capable of accessing a network 105. For example, a mobile device includes a processor for executing the recommendation module 199 and the recommendation module 199 can be an application stored in a memory of the mobile device. In the illustrated instance, the user 125a interacts with the user device 115a via signal line 131. The user 125n interacts with the user device 115n.

In some instances, the recommendation module 199 acts in part as a thin-client application that may be stored on the user devices 115a, 115n and in part as components that may be stored on one or more of the social network server 101, the third-party server 142 and the asset hosting site 144. In other instances, the user device 115 includes a browser application (not shown). The recommendation module 199 may be extensible code stored and executed by the browser application. For example, the recommendation module 199 may be stored in a cache of the browser application. A processor of the user device 115 (not pictured) may execute the recommendation module 199.

In some instances, the recommendation module 199 may be stored on a third-party server 142, which is communicatively coupled to the network 105 via signal line 134. In some instances, the third-party server 142 can be a hardware server that includes a processor, a memory and network communication capabilities. The third-party server 142 sends and receives data to and from other entities of the recommendation system 100 via the network 105.

In some instances, the recommendation module 199 receives a request for a recommendation describing one or more multi-party communication sessions on a social network application 109 from a user 125. The recommendation module 199 retrieves user profile data for the user 125. The recommendation module 199 determines a user social interest model based at least in part on the user profile data. In some instances, the user social interest model includes a vector of binary values. For example, each binary value in the vector corresponds to an entity describing an interest.

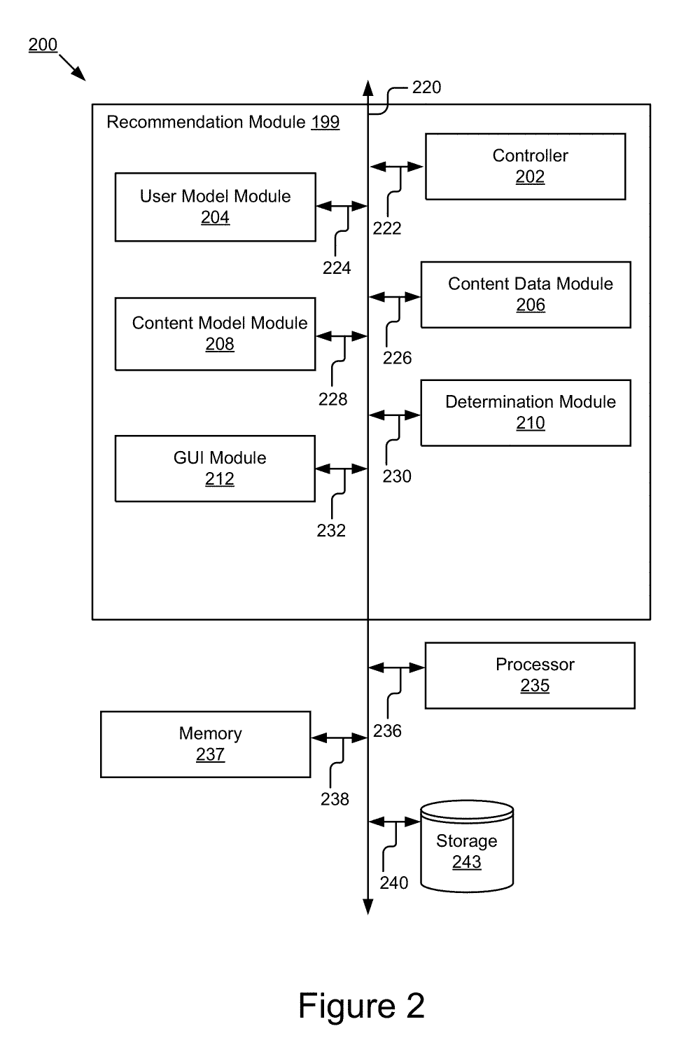

The recommendation module 199 determines one or more content identifiers associated with multi-party communication sessions on the social network application 109. The recommendation module 199 determines interest data describing content data associated with the one or more content identifiers. The recommendation module 199 determines one or more content models describing the content data. In some instances, a content model includes a vector of binary values that describe the content data. The recommendation module 199 determines whether a match exists between the user social interest model and the one or more content models. The recommendation module 199 determines one or more multi-party communication sessions for the recommendation responsive to determining the match exists. The recommendation module 199 transmits the recommendation to the user 125. The recommendation module 199 is described below in more detail with reference to FIGS. 2-5.

Referring now to FIG. 2, an example of the recommendation module 199 is shown in more detail. FIG. 2 is a block diagram of a computing device 200 that includes a recommendation module 199, a processor 235, a memory 237 and a storage 243. The components of the computing device 200 are communicatively coupled by a bus 220. In some instances, the computing device 200 can be one of a social network server 101, a user device 115, an asset hosting site 144 and a third-party server 142.

The processor 235 includes an arithmetic logic unit, a microprocessor, a general purpose controller or some other processor array to perform computations and provide electronic display signals to a display device. The processor 235 is coupled to the bus 220 for communication with the other components via signal line 236. Processor 235 processes data signals and may include various computing architectures including a complex instruction set computer (CISC) architecture, a reduced instruction set computer (RISC) architecture, or an architecture implementing a combination of instruction sets. Although FIG. 2 includes a single processor 235, multiple processors 235 may be included. Other processors, operating systems, sensors, displays and physical configurations can be possible.

The memory 237 stores instructions and/or data that may be executed by the processor 235. The memory 237 is coupled to the bus 220 for communication with the other components via signal line 238. The instructions and/or data may include code for performing the techniques described herein. The memory 237 may be a dynamic random access memory (DRAM) device, a static random access memory (SRAM) device, flash memory or some other memory device. In some instances, the memory 237 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The storage 243 can be a non-transitory memory that stores data for providing the functionality described herein. The storage 243 is communicatively coupled to the bus 220 via signal line 240. The storage 243 may be a dynamic random access memory (DRAM) device, a static random access memory (SRAM) device, flash memory or some other memory devices. In some instances, the storage 243 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some instances, the storage 243 stores user profile data describing one or more user profiles upon consent of users 125. In some instances, the user profile data may include profile information of user 125 from the social network application 109. For example, profile information may include a description of the following information for the user 125: employment information, education, places lived, age, relationship status, gender, interests, a description of the most recent video watched by the user 125, etc. In some instances, the user profile data may describe social network data of user 125 from the social network application 109. For example, the social network data may include search history, comments, posts, acknowledgments, browsing history, etc. In another example, the social network data may include content consumption history, content uploaded, channel subscriptions, etc. In some instances, the storage 243 stores social graph data. Social graph data can include data describing the social graph for a user 125. For example, the social graph can be a social graph associated with the social network application 109. In some examples, the social graph can reflect a mapping of users 125 and how they can be related.

In some instances, the storage 243 stores a user social interest model for a user 125. The user social interest model may be data describing the interests of the user 125. For example, the user social interest model may be a vector of binary values describing interests of the user 125. In some instances, the user social interest model can be based on profile information for the user 125 that describes the most recent video watched by the user 125. For example, the user 125 watches a video describing a Indian cooking recipe, and the user social interest model indicates that the user 125 can be interested in multi-party communication sessions related to Indian cooking recipes since that can be the most recent video watched by the user 125.

In some instances, the storage 243 stores multi-party communication session data describing one or more multi-party communication sessions. For example, the multi-party communication session data may include a description, a name, a list of participants, a session type (e.g., chat session, voice conference, video conference), a privacy type (e.g., public, private), a status (e.g., in progress, scheduled for a future time) and/or associated content data for a multi-party communication session. In some instances, the associated content data includes one or more content identifiers that identify the content (e.g., a video, picture, text describing a chat between two or more users 125, etc.) that can be an element of the multi-party communication session. For example, a content identifier may be an asset ID described in FIG. 1.

Assume, for example, that two users 125 may be engaged in a multi-party communication session. The two users 125 may be communicating by a video chat, voice chat, text chat, etc. The users 125 may be chatting while watching a video of a movie. Here, the movie may be the content. For example, the two users 125 may be engaged in a first multi-party communication session in which the users 125 may be watching a video related to the Republican National Convention. The two users 125 may provide comments to each other via text, voice, video, etc. For example, a user 125 may say verbally that she disagrees with a statement by a presidential candidate viewed by the user 125 from the video. The verbal comment made by the user 125 can be converted to text by the asset hosting site 144, and this text can also be content associated with the multi-party communication session that can be used to determine whether to recommend the first multi-party communication session to another user 125 that has requested a recommendation for a multi-party communication to join. This concept is described in more detail below with reference to “user-generated data.” Similarly, one of the users 125 can make a comment about the video via a chat input. For example, the user 125 types “Wow, that candidate has an interesting idea; I'm not sure if I agree with it, but it is interesting.” The text of this chat can also be content associated with the multi-party communication session that can be used to determine whether to recommend the multi-party communication session to another user 125 that has requested a recommendation for a multi-party communication to join. This concept is described in more detail below with reference to “user-generated data.”

In some instances, the storage 243 stores interest data describing the content data (e.g., videos, music, photos, books, etc). For example, the storage 243 stores metadata associated with the content. The metadata may include one or more of: a title; a description; tag information; a time length, etc. In some instances, the interest data includes comments or acknowledgments by users 125 associated with the content.

In some instances, the interest data may be user-generated data. The content may be generated by user 125 while participating in a multi-party communication session. For example, during a chat between two users 125, the two users 125 may communicate the words or phrase “Republican National Convention” a number of times. Because the phrase “Republican National Convention” was used by the two users 125, the metadata describing the text or chat may include the description “Republican National Convention.” In some instances, the two users 125 may share links with each other during a multi-party session. For example, a user 125 may share a link to a newspaper article related to the Republican National Convention. Because the newspaper article is related to the Republican National Convention, the metadata describing the link shared by user 125 may include the description “Republican National Convention.”

The storage 243 may store content models describing content data associated with multi-party communication sessions. In some instances, the storage 243 may store a vector of binary values describing the content data. For example, each binary value corresponds to an entity describing the content data. For example, an entity may be a portion of the title or description of a video. In another example, the entity may be a description of text communicated by users 125 in the multi-party communication session.

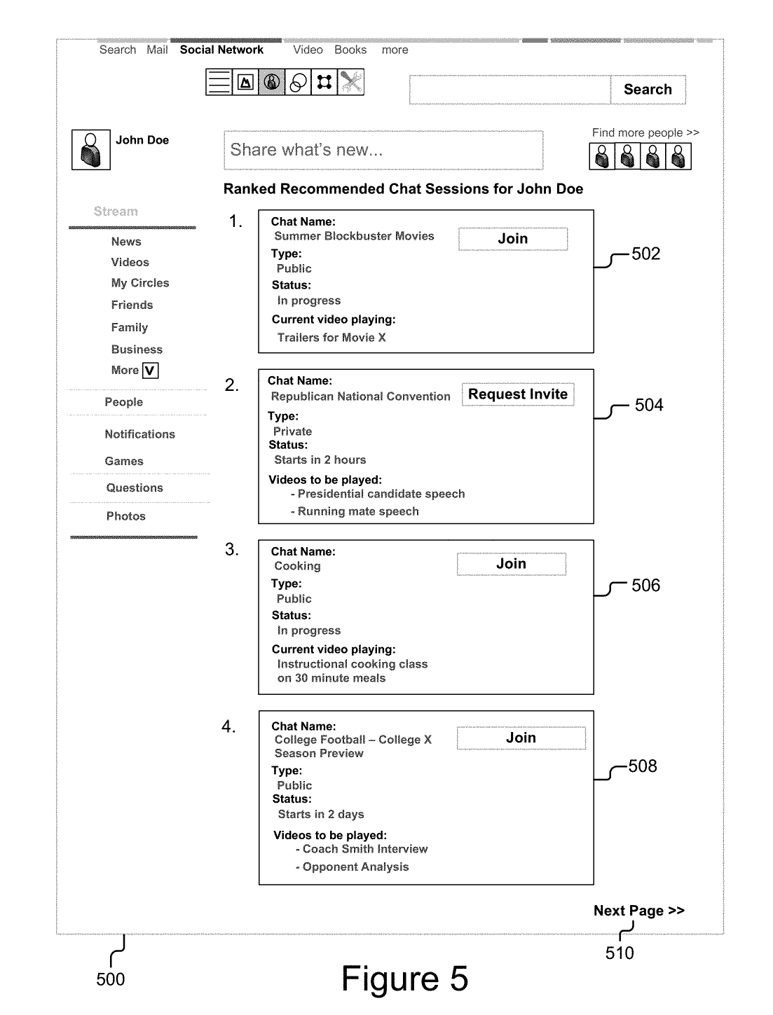

In some instances, the storage 243 stores graphical data describing a user interface for displaying recommendations to a user 125. An example of a user interface for displaying recommendations is described below in reference to FIG. 5. In some instances, the storage 243 stores graphical data describing a user interface for displaying an indication of no matches.

The recommendation module 199 includes: a controller 202, a user model module 204, a content data module 206, a content model module 208, a determination module 210 and a GUI module 212. These components of the recommendation module are communicatively coupled to each other via the bus 220.

The controller 202 can be software including routines for handling communications between the recommendation module 199, other components of the computing device 200 and other entities of the recommendation system 100. In some instances, the controller 202 can be a set of instructions executable by the processor 235 to provide the functionality described below for handling communications between the recommendation module 199, other components of the computing device 200 and other entities of the recommendation system 100. In some other instances, the controller 202 can be stored in the memory 237 of the computing device 200 and can be accessible and executable by the processor 235. The controller 202 may be adapted for cooperation and communication with the processor 235 and other components of the computing device 200 via signal line 222.

The controller 202 handles communication between the recommendation module 199, other components of the computing device 200 and other entities of the recommendation system 100. For example, the controller 202 receives a request for a recommendation describing one or more multi-party communication sessions on a social network application 109 from a user 125. In some instances, the request may be a one-time request. For example, the user 125 requests recommendations available at the time of the request. In some instances, the request may be a recurring request. For example, the user 125 requests recommendations at periodic times in the future. In some instances, the request may be scheduled to provide the recommendation at a specific date and time. In another example, the controller 202 receives graphical data for providing a user interface to a user 125 from the GUI module 212 and sends the graphical data to a user device 115, causing the user device 115 to present the user interface to the user 125.

In some instances, the controller 202 receives data from other components of the recommendation module 199 and stores the data in the storage 243. For example, the controller 202 receives a user social interest model from the user model module 204. The controller 202 stores the user social interest model in the storage device 243. In some instances, the controller 202 retrieves data from the storage device 243 and sends the data to components of the recommendation module 199. For example, the controller 202 retrieves user profile data from the storage device 243 and sends the data to the user model module 204.

The user model module 204 can be software including routines for determining user social interest models. In some instances, the user model module 204 can be a set of instructions executable by the processor 235 to provide the functionality described below for determining user social interest models. In some other instances, the user model module 204 can be stored in the memory 237 of the computing device 200 and can be accessible and executable by the processor 235. The user model module 204 may be adapted for cooperation and communication with the processor 235 and other components of the computing device 200 via signal line 224.

The user model module 204 retrieves user profile data for a user 125. In one instance, the user model module 204 receives user profile data from a social network application 109. For example, the user model module 204 may receive profile information of user 125 from the social network application 109 via the controller 202. The profile information may include a description, employment information, education, places lived, age, relationship status, gender, interests, etc. In some instances, the user profile data may include social network data of user 125 from the social network application 109. For example, the social network data may include search history, comments, posts, acknowledgments, browsing history, etc. The acknowledgments can be a positive or negative endorsement.

In some instances, the social network data may include content consumption history, content uploaded, channel subscriptions, etc. For example, the user model module 204 receives data describing consumption history, content uploaded or channels subscribed to by user 125 from the asset hosting site 144 via the network 105. In some instances, the user model module 204 retrieves the asset history for a user 125 from the asset hosting site 144 stored in user database 114. In some instances, the user model module 204 stores the user profile data for the user 125 in storage 243.

In some instances, the user model module 204 receives the most recent content consumed by a user 125. The most recent content consumed by the user 125 may be a video viewed by user 125. For example, the user 125 may have most recently viewed a video related to the Republican National Convention. In some instances, the most recent content consumed by the user 125 may be a website or a webpage that user 125 may be visiting. For example, the user 125 may be viewing a blog or a forum related to Indian cooking. In some instances, the most recent content consumed by the user 125 may be a multi-party communication session that the user 125 participated in. For example, the user 125 participated in a multi-party communication session having a topic related to the Republican National Convention. The most recent content consumed can be any content, e.g., a song, a photo, a newspaper article, a blog, a video game, etc.

In some instances, the user model module 204 receives data describing user-generated data. The user 125 may have participated in a multi-party communication session that the participants talked or chatted about a topic. For example, the topic may be related to the Republican National Convention. The user model module 204 receives data describing this user-generated data. In another example, during the multi-party communication session, the user 125 may have shared a link with another user 125 for news articles related to the Republican National Convention. This may also be user generated data that is communicated to the user model module 204. The user model module 204 then generates a user social interest model based at least in part on the user generated data. The user model can be generated by the user model module 204 based on additional data including, for example, the social graph data for the user 125.

In some instances, the user model module 204 receives social graph data for user 125 from social network application 109. Social graph data can include data describing the social graph for a user 125. For example, the social graph may be a social graph associated with the social network application 109. In some instances, the user model module 204 stores the social graph data in storage 243.

The user model module 204 determines a user social interest model for user 125. In some instances, the user model module 204 determines the user social interest model describing interests of the user 125. For example, the user social interest model may be a vector of binary values. Each binary may correspond to an entity describing an interest of user 125. For example, the user 125 may have an interest in Indian cooking and the user social interest model indicates that the user 125 may be interested in Indian cooking or any other related topic. The user model module 204 may determine the user social interest model based at least in part on the user profile data. For example, the user model module 204 may determine an interest of user 125 based at least in part on the profile information for user 125 from the social network application 109. In another example, the user model module 204 may determine an interest of the user 125 based at least in part on a post, a comment or an acknowledgement by the user 125 on social network application 109. In another example, the user model module 204 may determine an interest of the user 125 based at least in part on a past query or recent browsing history by user 125. The user model module 204 may determine an interest based at least in part on content consumption history, content uploaded or channels subscribed to by user 125. The user model module 204 may store the user social interest model in storage 243. In some instances, the user model module 204 determines an interest of the user 125 based on the most recent content consumed by a user 125. The most recent content consumed by user 125 may be a video, a website, a song, a photo, a newspaper article, a blog, a video game, a multi-party communication session etc. For example, the user 125 most recently visited a blog related to Indian cooking. In some instances, the user model module 204 determines that the user 125 may have an interest in Indian cooking based only on the most recent activity for the user 125 being that the user 125 visited the blog related to Indian cooking. Before the user 125 visited the blog, there may be nothing in the user profile data of user 125 to indicate that the user 125 may have an interest in Indian cooking. Therefore, the user model module 204 can determine new and recent interests of the user 125 and the recommendation module 199 can recommend a multi-party communication session for the user 125 based on this recent interest.

The content data module 206 can be software including routines for determining interest data describing content data associated with multi-party communication sessions. In some instances, the content data module 206 can be a set of instructions executable by the processor 235 to provide the functionality described below for determining interest data describing content data associated with multi-party communication sessions. In some other instances, the content data module 206 can be stored in the memory 237 of the computing device 200 and can be accessible and executable by the processor 235. The content data module 206 may be adapted for cooperation and communication with the processor 235 and other components of the computing device 200 via signal line 226.

The content data module 206 determines multi-party communication sessions from social network application 109. In some instances, the content data module 206 receives multi-party communication session data from the social network application 109. For example, the content data module 206 receives the data from the social network application 109 via the controller 109. The multi-party communication session data may describe one or more multi-party communication sessions on the social network application 109. For example, the multi-party communication session data may include a description, a name, a list of participants, a session type (e.g., chat session, voice conference, video conference), a privacy type (e.g., public, private), a status (e.g., in progress, scheduled for a future time) and/or associated content data. In some instances, the content data module 206 determines the multi-party communication sessions based at least in part on the list of participants not including user 125. The content data module 206 may store the multi-party communication session data in the storage 243.

In some instances, the associated content data includes one or more content identifiers. The content identifiers may identify content that is being consumed in a multi-party communication session. In some instances, the content identifiers may identify content that was consumed in a multi-party communication session. In other instances, the content identifiers may identify content that will be consumed by in a multi-party communication session. For example, the multi-party communication session data may include a queue of content to be shared in a multi-party communication session that includes the content identifiers. In some instances, the content may be one or more videos viewed by users 125. For example, the two users 125 viewed a video related to the Republican National Convention. In some instances, the content can be user-generated data. For example, the text of a communication between users 125 during the multi-party communication session. In some instances, the content may be content that a user 125 shares during the multi-party communication session. For example, the users 125 may share links, photos, songs, newspaper articles, web sites, etc. with another user 125 The content data module 206 determines one or more content identifiers associated with the multi-party communication sessions. In some instances, the content data module 206 determines the one or more content identifiers based at least in part on the multi-party communication session data. For example, the content data module 206 retrieves the content identifiers from the associated content data in the multi-party communication session data.

The content data module 206 determines interest data describing content data associated with the content identifiers. In some instances, the content data module 206 retrieves the interest data from asset hosting site 144. For example, the content data module 206 retrieves the interest data from asset hosting site 144 via the controller 202 and network 105. In some instances, the content data module 206 sends a request to asset hosting site 144 that includes the content identifiers. The asset hosting site 144 may transmit metadata describing the content data to the content data module 206 via the controller 202 and network 105. The metadata may include one or more of: a title; a description; tag information; a time length, etc. In some instances, the interest data includes comments or acknowledgments associated with the content. The content data module 206 may store the interest data in storage 243. In one example, content may be a video and the metadata includes the description “Republican National Convention.” In another example, the content may be text communicated during a multi-party communication session. The metadata describing the text may include a description “Republican National Convention” based on a user 125 communicating the phrase “Republican National Convention” during the multi-party communication session. The interest data may include “Republican National Convention” based on the video and text.

The content model module 208 can be software including routines for determining content models describing content. In some instances, the content model module 208 can be a set of instructions executable by the processor 235 to provide the functionality described below for determining content models describing content. In some other instances, the content model module 208 can be stored in the memory 237 of the computing device 200 and can be accessible and executable by the processor 235. The content model module 208 may be adapted for cooperation and communication with the processor 235 and other components of the computing device 200 via signal line 228.

The content model module 208 determines content models describing content. In some instances, the content model module 208 determines the content models based at least in part on the interest data. In some instances, the content model module 208 determines one or more content models based on data describing videos associated with the multi-party communication sessions. For example, the two users 125 may have viewed a video during a multi-party communication session related to the Republican National Convention and the content models can be generated based at least in part on this video. In some instances, the content model module 208 determines one or more content models based on metadata describing the text of a chat communicated between the two users 125. The metadata describing the text may be a description “Republican National Convention” and the content model may be generated based at least in part on this description.

In some instances, the content model may be a vector of binary values describing the content data. Each binary value corresponds to an entity describing the content. For example, a description of a video (e.g., Republican National Convention) may be an entity. In another example, a description of a text (e.g., Republican National Convention) may be an entity. The content model module 208 may store the one or more content models in storage 243.

The determination module 210 can be software including routines for determining recommendations. In some instances, the determination module 210 can be a set of instructions executable by the processor 235 to provide the functionality described below for determining recommendations. In some other instances, the determination module 210 can be stored in the memory 237 of the computing device 200 and can be accessible and executable by the processor 235. The determination module 210 may be adapted for cooperation and communication with the processor 235 and other components of the computing device 200 via signal line 230.

The determination module 210 determines whether a match exists between the user social interest model and the one or more content models. In some instances, the determination module 210 compares the user social interest model and the one or more content models. For example, the user model module 204 determines a vector of binary values for the user social interest model. The content model module 208 determines a vector of binary values for the one or more content models. The determination module 210 compares the vector of binary values for the user social interest model and the vector of binary values for the one or more content models. The determination module 210 may determine a match exists based at least in part on a number of entities in each vector that are the same. For example, both vectors may include two entities labeled “College X” and “College Football.” In some instances, the determination module 210 may determine a match exists based at least in part on a number of entities in each vector that may be similar. For example, one vector may include an entity labeled tagged “politics” and the other vector may include an entity tagged “Indian recipes.” In some instances, the determination module 210 determines a match exists based at least in part on comparing connections in the social graph for user 125 and the participants of a multi-party communication session. For example, the determination module 210 determines the number of connections for a user 125 included in a list of participants associated with a multi-party communication session. Therefore, the determination module 210 can determine multi-party communication sessions having participants familiar to user 125.

In some instances, the interest of the user 125 may be only based on the most recent content consumed by a user 125. Therefore, the match may be based on recent or new interests of the user 125. The user 125 may have most recently visited an Indian cooking blog. However, before the visit, nothing in the user profile data of user 125 may indicate an interest in Indian cooking. Therefore, the recommendation module 199 may provide recommendations based on recent and new interests of user 125.

In some instances, the determination module 210 determines a score for the match between the user social interest model and the one or more content models. For example, the score may be based at least in part on the number of same entities in the vectors, the number of similar entities in the vectors or the number of connections for user 125 included in the list of participants associated with a multi-party communication session. In some instances, the determination module 210 determines a match exists based at least in part on the score. For example, the determination module 210 determines a match exists based at least in part on the score exceeding a predetermined score threshold.

The determination module 210 determines one or more multi-party communication sessions for the recommendation. In some instances, the determination module 210 determines the multi-party communication sessions based on the match between the user social interest model and the content models. The determination module 210 may determine the multi-party communication sessions for the recommendation based on the content models describing the content or videos. The content may be associated with the multi-party communication sessions for the recommendation. In some instances, the recommendations may be determined based on the trend in popularity of a topic associated with each multi-party communication session at the time of the request. For example, during a time around or during the Republican National Convention, the topic “Republican National Convention” may be more popular than the topic “fly fishing.” Therefore, the recommendation module 199 may provide recommendations that may be currently popular or trending towards popularity.

The determination module 210 ranks the one or more multi-party communication sessions. In some instances, the determination module 210 ranks the multi-party communication sessions based on the score for the match between the user social interest model and the one or more content models. In some instances, the determination module 210 ranks the one or more multi-party communication sessions based on a number of participants associated with each multi-party communication session. For example, a higher number of participants results in a higher ranking. In some instances, the ranking may be based on the type of participants associated with each multi-party communication session. For example, the ranking may be based on the popularity of the participants. In some instances, the ranking may be based on the trend in popularity of a topic associated with each multi-party communication session at the time of the request.

The GUI module 212 can be software including routines for determining graphical data for causing the user device 115 to generate a GUI. In some instances, the GUI module 212 can be a set of instructions executable by the processor 235 to provide the functionality described below for determining graphical data for causing the user device 115 to generate a GUI. In some other instances, the GUI module 212 can be stored in the memory 237 of the computing device 200 and can be accessible and executable by the processor 235. The GUI module 212 may be adapted for cooperation and communication with the processor 235 and other components of the computing device 200 via signal line 232.

In some instances, the GUI module 212 determines graphical data for displaying a user interface for generating a recommendation GUI. For example, the GUI module 212 retrieves GUI data from storage 243. In some instances, the GUI module 212 determines a recommendation GUI for displaying recommendations to user 125. The recommendation GUI may include the multi-party communication sessions determined by the determination module 210. An example of a recommendation GUI is depicted in FIG. 5. In some instances, the GUI module 212 determines a recommendation GUI that displays top-ranked recommendations based on the ranking. In some instances, the GUI module 212 displays the recommendations in an order based on the ranking The GUI module 212 may transmit the graphical data to the controller 202. The controller 202 may transmit the graphical data to the user device 115. For example, the controller 202 may transmit the graphical data to the user device 115 via the network 105. The user device 115 may generate a recommendation GUI for display to the user 125 based at least in part on the graphical data determined by the GUI module 212. For example, the user device 115 stores a browser application on a non-transitory memory (not pictured) of the user device 115. The user device 115 includes a processor (not pictured) that executes the browser application. The browser application executes the browser and renders a recommendation GUI based at least in part on the graphical data.

In some instances, the GUI module 212 may determine graphical data for generating other user interfaces for display on user device 115. For example, the determination module 210 may determine that no matches exist between the user social interest model and the content models. In some instances, the GUI module 212 determines graphical data for generating a GUI indicating no matches exist. In some instances, the GUI may be a user interface for displaying a message to inform user 125 that no matches exist. The GUI module 212 may transmit the graphical data to the controller 202. The controller 202 may transmit the graphical data to the user device 115. For example, the controller 202 may transmit the graphical data to the user device 115 via the network 105.

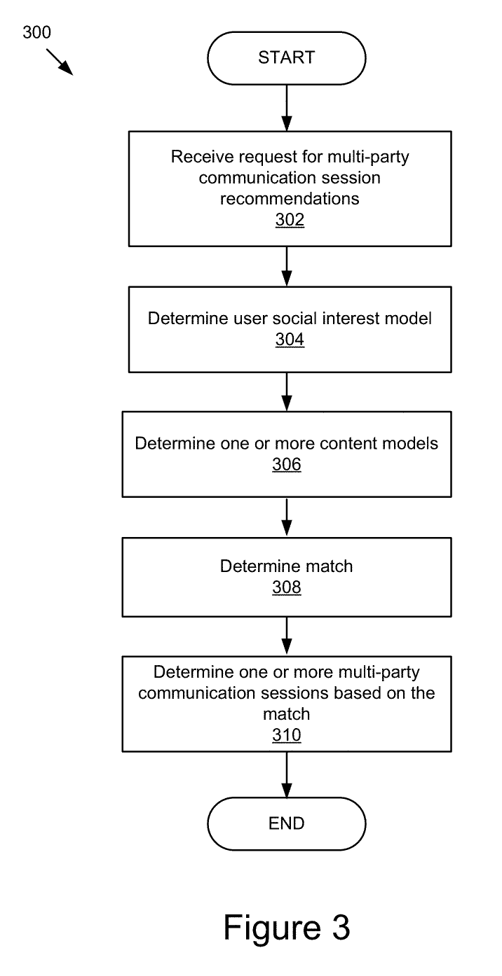

Referring now to FIG. 3, a flowchart of an example method 300 for recommending multi-party communication sessions on a social network application 109 is described. The controller 202 receives 302 a request for multi-party communication recommendations on a social network application 109 from a user 125. The user model module 204 determines 304 a user social interest model for user 125. The content model module 208 determines 306 one or more content models describing content data. The determination module 210 determines 308 a match between the user social interest model and one or more content models. The determination module 210 determines 310 one or more multi-party communication sessions based at least in part on the match.

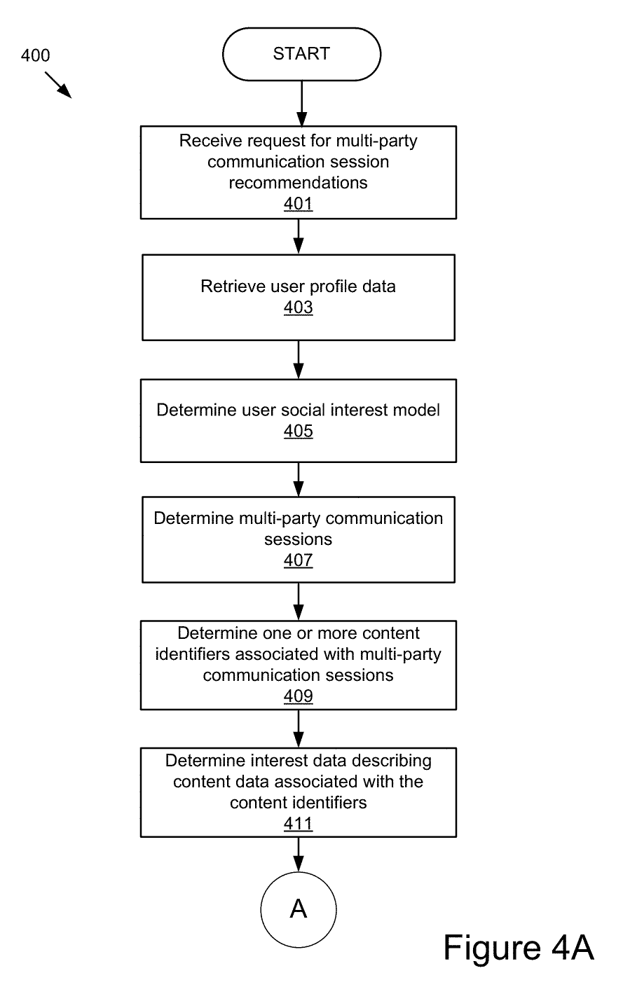

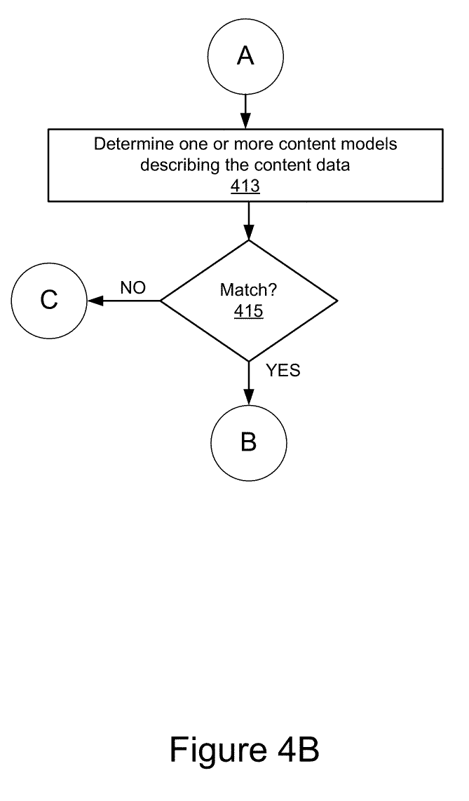

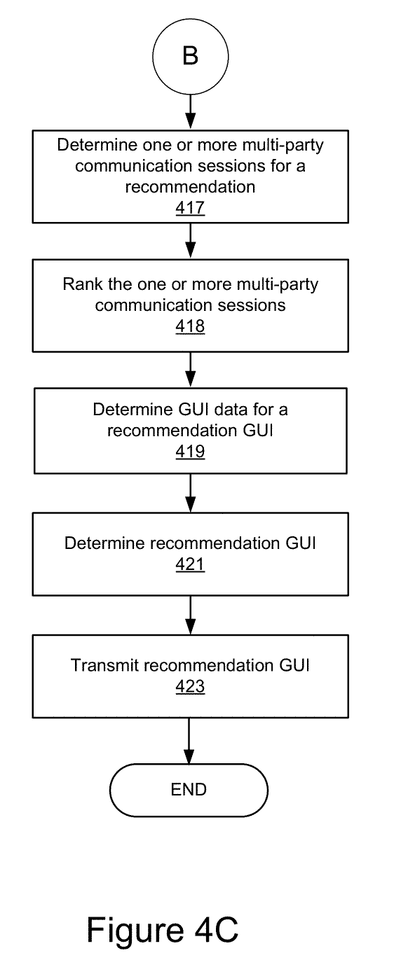

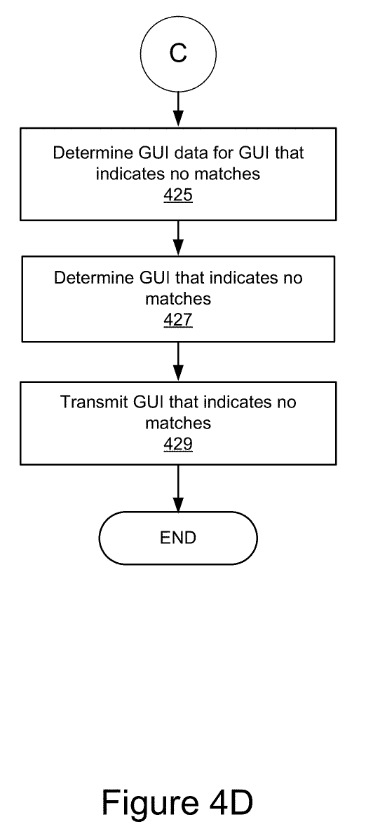

Referring now to FIGS. 4A-4D, flowcharts of another example method 400 for recommending multi-party communication sessions are described. Turning to FIG. 4A, the controller 202 receives 401 a request for multi-party communication session recommendations. The user model module 204 retrieves 403 user profile data. In some instances, the user profile data includes the most recent content consumed by a user 125. For example, the user 125 viewed a blog related to Indian cooking. The user model module 204 determines 405 a user social interest model. In some instances, the user social interest model may be based on the most recent content consumed by the user 125. The content data module 206 determines 407 multi-party communication sessions on the social network application 109. The content data module 206 determines 409 one or more content identifiers associated with the multi-party communication sessions. The content data module 206 determines 411 interest data describing content data associated with the content identifiers. In some instances, the content may be video. For example, two users 125 may view a video related to the Republican National Convention. In some instances, the content may be user-generated data during the multi-party communication session. For example, the two users 125 may discuss the Republican National Convention.

Referring to FIG. 4B, the content model module 208 determines 413 one or more content models describing the content data. In some instances, the content model may be based on a video. For example, the content model may be based on a description of the video. In other instances, the content model may be based on user-generated data. For example, the content model may be based on a topic discussed by two users 125 during a multi-party communication sessions. For example, two users 125 may discuss the Republican National Convention via chat or verbally. For verbal communications, the speech-to-text technology may be used to convert the verbal communication to text. The determination module 210 determines 415 whether a match exists between the user social interest model and the one or more content models. Responsive to determining a match exists, referring to FIG. 4C, the determination module 210 determines 417 one or more multi-party communication sessions for a recommendation. The determination module 210 ranks 418 the one or more multi-party communication sessions. In some instances, the ranking may be based on a number of participants associated with each multi-party communication session. In some instances, the ranking may be based on the trend in popularity of a topic associated with each multi-party communication session. The GUI module 212 determines 419 GUI data for a recommendation GUI. An example of a recommendation GUI is depicted in FIG. 5. The GUI module 212 determines 421 the recommendation GUI. In some instances, the GUI module 212 determines a recommendation GUI for displaying top-ranked multi-party communication sessions based on the ranking In some instances, the GUI module 212 orders the multi-party communication sessions based on the ranking The controller 202 transmits 423 the recommendation GUI. Otherwise, responsive to determining a match does not exist, referring to FIG. 4D, the GUI module 212 determines 425 GUI data for a GUI that indicates no matches. The GUI module 212 determines 427 the GUI that indicates no matches. The controller 202 transmits 429 the GUI that indicates no matches.

In some instances, at least a part of the recommendation module 199 may be stored and executed by an asset hosting site 144. In some instances, the controller 202 does not receive a request for recommendations. Instead of the request for recommendations, the controller 202 may receive current activity data describing the user's 125 current activity. In some instances the current activity data describes a video that the user 125 may be presently watching or a website that the user 125 may be presently visiting. For example, the user 125 may be watching a video about “Indian cooking” or visiting a website about Indian recipes “Indian cooking” and the controller 202 receives current activity data describing the video that the user 125 may be presently watching or the website that the user 125 may be presently visiting. The user model module 204 determines the user social interest model based at least in part on the current activity data, i.e., the user model module 204 determines the user social interest model based on the video that the user 125 may be presently watching or a website that the user 125 may be presently visiting. For example, the user social interest model may be determined based on current activity data indicating that the user 125 may be presently watching a video about “Indian cooking” or may be visiting a website about Indian recipes. The determination module 210 may determine one or more multi-party communication sessions to recommend to the user 125 based at least in part on the current activity data. Thus, in some instances the recommendation module 199 can recommend multi-party communication sessions to the user 125 without receiving a request for recommendations.

In some instances, the user model module 204 determines the user social interest model based on a description of the most recent video watched by the user 125. For example, the user 125 watches a video describing an Indian cooking recipe, and the user social interest model indicates that the user 125 may be interested in multi-party communication sessions related to Indian cooking recipes since that may be the most recent video watched by the user 125. In some instances, the determination module 210 determines multi-party communication sessions that may be viewing or sharing videos that can be similar to the video that was most recently watched by the user 125. For example, a video may be similar if it has similar metadata (e.g., tags, etc.) to the video that was most recently watched by the user 125. In some instances, the similarity of the video may be determined based on comments left for the videos. In some instances, the determination module 210 determines multi-party communication sessions having content data related to the video most recently watched by the user 125 based on data generated as a result of speech-to-text conversion for conversation in a multi-party communication session. For example, in a multi-party communication session, two users 125 may discuss Indian cooking which can be related to the video's topic “Indian recipes.” The determination module 210 may be configured to determine that videos can be similar in other ways.

FIG. 5 is a graphic representation 500 of an example user interface for recommending multi-party communication sessions on a social network application 109 to a user 125. In the illustrated implementation, the user interface includes the four top-ranked recommendations 502, 504, 506 and 508 that can be in an order based on a ranking Although only four recommendations 502, 504, 506 and 508 are illustrated, the user interface may include any number of recommendations. Each recommendation may include a name, a privacy type, a status and associated content. The user interface includes a link 510 for viewing other recommendations that have rankings that can be lower than the rankings for recommendations 502, 504, 506 and 508. For example, a user 125 may view the other recommendations by clicking on the link 510.

In some instances, the associated content may be content being consumed at a current time. For example, recommendation 502 includes a video “Trailers for Movie X” that may be currently playing in a multi-party communication session in progress. In other instances, the associated content may be content that may be consumed in a multi-party communication session at a future time. For example, recommendation 504 includes a queue of videos including “Presidential candidate speech” and “Running mate speech” that may be played in a multi-party communication session starting at a future time.

In some instances, a multi-party communication session may be a private communication session. The user 125 may request an invitation to join the multi-party communication session. For example, recommendation 504 includes a private type of multi-party communication session. Also, recommendation 504 includes a “Request Invite” button. User 125 may request an invitation to join the private multi-party communication session by clicking the “Request Invite” button. In some instances, a multi-party communication session may be a public communication session. For example, recommendation 508 includes a “Join” button. User 125 may join the public multi-party communication by clicking the “Join” button. In some instances, a recommendation may include a description of the multi-party communication session and a list of participants.

In the above description, for purposes of explanation, numerous specific details are set forth in order to provide a thorough understanding of the specification. The disclosure can be practiced without these specific details. In other instances, structures and devices are shown in block diagram form in order to avoid obscuring the description. For example, the disclosure is described in one instance primarily with reference to user interfaces and particular hardware. However, the disclosure applies to any type of computing device that can receive data and commands, and any peripheral devices providing services.

Reference in the specification to “one instance” or “an instance” means that a particular feature, structure, or characteristic described in connection with the instance is included in at least one instance of the description. The appearances of the phrase “in one instance” in various places in the specification are not necessarily all referring to the same instance.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware instance, an entirely software instance or an instance containing both hardware and software elements. In a preferred instance, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description above. In addition, the specification is not described with reference to any particular programming language. It will be appreciated that a variety of programming languages may be used to implement the teachings of the specification as described herein.

The foregoing description of the instances of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the. Additionally, the disclosure is in no way limited to implementation in any specific programming language, or for any specific operating system or environment. Accordingly, the disclosure is intended to be illustrative, but not limiting, of the scope of the specification, which is set forth in the following claims.

1. (canceled).

2. A system comprising:
a processor; and
a memory storing instructions that, when executed by the processor cause the system to perform operations comprising:
receiving user profile data of a first user;
determining a user interest model based on the user profile data;
identifying a plurality of multi-party conference sessions on a social network;
determining session data of a first multi-party conference session from the plurality of multi-party conference sessions, the session data including a plurality of participants of the first multi-party conference session, a media content item queued for group consumption by the plurality of participants within the first multi-party conference session, and group discussion relating to the media content item generated by the plurality of participants in the first multi-party conference session;
determining a content model for the first multi-party conference session based on the session data including the media content item and the group discussion relating to the media content item;
performing a comparison between the user interest model and the content model;
determining whether the user interest model is matching the content model based on the comparison;
responsive to determining that the user interest model is matching the content model, generating a recommendation of the first multi-party conference session; and
transmitting instructions to a client device that cause a display of the recommendation of the first multi-party conference session to the first user, the recommendation of the first multi-party conference session including a selectable graphic element for the first user to join the first multi-party conference session as a participant of the first multi-party conference session.

3. The system of claim 2, wherein determining the content model for the first multi-party conference session based on the session data including the media content item and the group discussion relating to the media content item comprises:
determining first metadata of the media content item based on a content identifier of the media content item;
determining second metadata of the group discussion relating to the media content item from a conversation of the plurality of the participants in the first multi-party conference session; and
determining the content model describing the media content and the group discussion relating to the media content item based on the first metadata and the second metadata.

4. The system of claim 2, wherein performing the comparison between the user interest model and the content model includes determining a score.

5. The system of claim 4, wherein determining that the user interest model is matching the content model is based on the score satisfying a predetermined threshold.

6. The system of claim 2, wherein the user profile data includes browsing data describing a recent browsing history of the first user, graph data describing social graph data including connections of the first user in the social network, and current activity data describing a current activity of the first user.

7. The system of claim 4, wherein generating the recommendation of the first multi-party conference session includes determining the first multi-party conference session as top of the plurality of multi-party conference sessions based on the score.

8. The system of claim 2, wherein the media content item includes a video relating to a topic of the first multi-party conference session and the first multi-party conference session includes a queue of media content items for group consumption by the plurality of participants within the first multi-party conference session.

9. The system of claim 2, wherein the first multi-party conference session includes one from a group of a multi-party conference session in progress and a multi-party conference session scheduled for a future time.

10. The system of claim 2, wherein the session data includes a description of the first multi-party conference session, a name of the first multi-party conference session, a list of participants, a type of the first multi-party conference session, a privacy type of the first multi-party conference session, a status of the first multi-party conference session, and associated content of the first multi-party conference session.

11. A method comprising:
retrieving user profile data of a first user;
determining a user interest model based on the user profile data;
identifying a plurality of multi-party conference sessions on a social network;
determining session data of a first multi-party conference session from the plurality of multi-party conference sessions, the session data including a plurality of participants of the first multi-party conference session, a media content item queued for group consumption by the plurality of participants within the first multi-party conference session, and group discussion relating to the media content item generated by the plurality of participants in the first multi-party conference session;
determining a content model for the first multi-party conference session based on the session data including the media content item and the group discussion relating to the media content item;
performing a comparison between the user interest model and the content model;
determining whether the user interest model is matching the content model based on the comparison;
responsive to determining that the user interest model is matching the content model, generating a recommendation of the first multi-party conference session; and
transmitting instructions to a client device that cause a display of the recommendation of the first multi-party conference session to the first user, the recommendation of the first multi-party conference session including a selectable graphic element for the first user to join the first multi-party conference session as a participant of the first multi-party conference session.

12. The method of claim 11, wherein determining the content model for the first multi-party conference session based on the session data including the media content item and the group discussion relating to the media content item comprises:
determining first metadata of the media content item based on a content identifier of the media content item;
determining second metadata of the group discussion relating to the media content item from a conversation of the plurality of the participants in the first multi-party conference session; and
determining the content model describing the media content and the group discussion relating to the media content item based on the first metadata and the second metadata.

13. The method of claim 11, wherein performing the comparison between the user interest model and the content model includes determining a score.

14. The method of claim 13, wherein determining that the user interest model is matching the content model is based on the score satisfying a predetermined threshold.

15. The method of claim 11, wherein the user profile data includes browsing data describing a recent browsing history of the first user, graph data describing social graph data including connections of the first user in the social network, and current activity data describing a current activity of the first user.

16. The method of claim 13, wherein generating the recommendation of the first multi-party conference session includes determining the first multi-party conference session as top of the plurality of multi-party conference sessions based on the score.

17. The method of claim 11, wherein the media content item includes a video relating to a topic of the first multi-party conference session and the first multi-party conference session includes a queue of media content items for group consumption by the plurality of participants within the first multi-party conference session.

18. The method of claim 11, wherein the first multi-party conference session includes one from a group of a multi-party conference session in progress and a multi-party conference session scheduled for a future time.

19. The method of claim 11, wherein the session data includes a description of the first multi-party conference session, a name of the first multi-party conference session, a list of participants, a type of the first multi-party conference session, a privacy type of the first multi-party conference session, a status of the first multi-party conference session, and associated content of the first multi-party conference session.
